(19) United States
(12) Patent Application Publication
(10) Pub. No.: US 2013/0070247 A1
(43) Pub. Date: Mar. 21, 2013

(54) SPECTROSCOPIC MEASUREMENT DEVICE, AND SPECTROSCOPIC MEASUREMENT METHOD

(71) Applicant: Tatsuaki FUNAMOTO, Shiojiri (JP)

(72) Inventor: Tatsuaki FUNAMOTO, Shiojiri (JP)

(73) Assignee: Seiko Epson Corporation, Tokyo (JP)

(21) Appl. No.: 13/606,813

(22) Filed: Sep. 7, 2012

(30) Foreign Application Priority Data
Sep. 16, 2011 (JP) 2011-203285

(51) Int. Cl. G01J 3/51

(52) U.S. Cl. 356/416

(57) ABSTRACT

A spectroscopic measurement device includes a variable wavelength interference filter having a stationary reflecting film, a movable reflecting film, and an electrostatic actuator adapted to vary the gap amount of the inter-reflecting film gap in accordance with a voltage applied thereto, a detector adapted to detect the light intensity of the light, and a control circuit section adapted to measure the dispersion spectrum of the measurement object light, the control circuit section includes a peak detection section adapted to detect a peak-corresponding gap amount, a filter drive section that varies the gap amount to the constant interval gap amounts and the peak-corresponding gap amount in a stepwise manner, and a spectroscopic measurement section that obtains the light intensities corresponding respectively to the constant interval gap amounts and the peak-corresponding gap amount.

### BACKGROUND

1. Technical Field

The present invention relates to a spectroscopic measurement device and a spectroscopic measurement method.

2. Related Art

In the past, there has been known a variable wavelength interference filter having a pair of reflecting films opposed to each other and varying the distance between the reflecting films to thereby take out the light having a predetermined wavelength out of the light as the measurement object. Further, there has been known a spectroscopic measurement device for measuring the dispersion spectrum of the light as the measurement object using such a variable wavelength interference filter as described above (see, e.g., JP-A-2005-308688 (Document 1)).

Document 1 describes the optical device provided with the variable wavelength interference filter having reflecting films disposed on respective surfaces of a pair of substrates, the surfaces being opposed to each other. The variable wavelength interference is capable of varying the gap (the air gap) between the reflecting films due to voltage application. Further, it is described that in the optical device, in order to adjust the reference position of the air gap, the intensity of the light transmitted through the variable wavelength interference filter is monitored while varying the voltage to be applied to the variable wavelength interference filter in a stepwise manner.

Incidentally, in the spectroscopic measurement device, the light intensity with respect to each wavelength is detected in order to obtain the dispersion spectrum of the measurement object light. However, in the case of varying the voltage to be applied to the variable wavelength interference filter in a stepwise manner as described in Document 1, or the case of varying the gap between the reflecting films in a stepwise manner at regular intervals, accurate dispersion spectrum fails to be obtained in some cases.

FIG. 7 is a diagram showing the dispersion spectrum obtained by an existing spectroscopic measurement device. In FIG. 7, the dotted line represents the actual spectrum curve of the measurement object light, the plotted points represent the light intensity measured by the existing spectroscopic measurement device, the solid line represents the spectrum curve obtained by connecting the plotted points.

As shown in FIG. 7, if the light intensity is detected at the intervals of the measured wavelengths set to the regular intervals, it is not achievable to detect accurate peak position with respect to such measurement object light as to have a peak wavelength between the two measured wavelengths adjacent to each other. Therefore, there has been a problem that it is not achievable to obtain the accurate spectrum curve even if the spectrum curve is obtained based on the light intensity values of the measured wavelengths obtained by such measurement as described above.

On the other hand, although it is also possible to detect accurate peak position of the measurement object light by decreasing the intervals of the measured wavelengths, on this occasion, there has been a problem that the time necessary for the measurement increases because the measurement pitch is shortened, and the number of times of the measurement increases.

### SUMMARY

An advantage of some aspects of the invention is to provide a spectroscopic measurement device and a spectroscopic measurement method capable of promptly measuring the dispersion spectrum with high accuracy.

An aspect of the invention is directed to a spectroscopic measurement device including a variable wavelength interference filter having a first reflecting film, a second reflecting film opposed to the first reflecting film via a gap of a predetermined gap amount, and a gap amount varying section adapted to vary the gap amount, a detection section adapted to detect the light intensity of the light taken out by the variable wavelength interference filter, and a control section adapted to control the variable wavelength interference filter to measure a dispersion spectrum of measurement object light, the control section includes a peak detection section adapted to detect a peak-corresponding gap amount, which is a gap amount for taking out the light with a peak wavelength of the measurement object light using the variable wavelength interference filter, a filter drive section adapted to control the gap amount varying section to vary the gap amount of the gap, and a spectroscopic measurement section adapted to obtain the light intensity corresponding to the gap amount set by the filter drive section, and measure the dispersion spectrum, the filter drive section varies the gap amount of the gap to constant interval gap amounts at a predetermined measurement pitch, and the peak-corresponding gap amount in a stepwise manner, and the spectroscopic analysis section obtains light intensities corresponding respectively to the gap amounts with the predetermined measurement intervals and the peak-corresponding gap amount.

In this aspect of the invention, the peak-corresponding gap amount corresponding to the peak wavelength of the measurement object light is detected by the peak detection section. Further, the filter drive section varies the gap amount of the gap to constant interval gap amounts at a predetermined measurement pitch, and the peak-corresponding gap amount detected by the peak detection section in a stepwise manner. Further, the spectroscopic measurement section measures the light intensity corresponding to each of the gap amounts.

Therefore, in this aspect of the invention, not only the light intensity of the light taken out in accordance with the constant interval gap amounts, but also the light intensity of the light with the peak wavelength of the measurement object light can be obtained. Here, the “peak wavelength of the measurement object light” described in the specification includes the case of slightly shifted from the peak wavelength in addition to the accurate peak wavelength of the measurement object light.

In this case, by performing the measurement of the light intensity corresponding to the peak-corresponding gap amount, it is possible to make the peak position of the dispersion spectrum obtained by the measurement coincide with or approximate to the peak position of the measurement object light even in the case in which the measurement pitch corresponding to the interval of the constant interval gap amounts is set to a little bit large value. Thus, it is possible to perform the measurement of the dispersion spectrum with high accuracy.

Further, the number of times of setting of the gap amount can be reduced, and it is possible to promptly perform the measurement compared to the case of increasing the accuracy of the dispersion spectrum by setting the measurement pitch to a shorter value without detecting the peak-corresponding gap amount.

According to the configuration described above, in this aspect of the invention, it is possible to promptly measure the accurate dispersion spectrum.

In the spectroscopic measurement device according to the above aspect of the invention, it is preferable that there is further provided a mode switching section adapted to switch an operation mode of the spectroscopic measurement device to one of a peak detection mode of detecting the peak-corresponding gap amount, and a measurement mode of measuring the dispersion spectrum of the measurement object light, and when the mode switching section switches the operation mode to the peak detection mode, the filter drive section continuously varies the gap amount of the gap, and the peak detection section detects a local maximum point of the light intensity based on a variation state of the light intensity detected by the detection section, and detects the gap amount, which is set by the filter drive section when the local maximum point is detected, as the peak-corresponding gap amount.

According to this configuration, in the peak detection mode, it is not necessary to detect the accurate value of the light intensity, and it is sufficient that the peak position can be detected. In this case, by varying continuously (making a sweep operation with) the gap amount of the gap between the reflecting films, and detecting the local maximum point from the variation state of the variation in the light intensity detected by the detection section, the peak wavelength can easily and promptly be detected.

In this case, the position of the peak wavelength of the measurement object light can promptly be detected compared to the method of repeatedly performing the procedure of varying the gap amount in a stepwise manner, waiting until the fluctuation of the gap amount vanishes and then detecting the light intensity at the time point when the fluctuation of the gap amount vanishes in each of the steps. In other words, since the peak detection section can promptly detect the peak-corresponding gap amount, and can promptly make a transition to the measurement mode, the time necessary for the spectroscopic measurement can also be reduced.

In the spectroscopic measurement device according to the above aspect of the invention, it is preferable that the gap amount varying section varies the gap amount of the gap in accordance with a level of the voltage applied, and when the mode switching section switches the operation mode to the peak detection mode, the filter drive section varies the voltage to be applied to the gap varying section in a stepwise manner at voltage intervals corresponding to a peak detection pitch smaller than a measurement pitch.

Here, in the peak detection mode, as described above, it is not necessary to wait until the fluctuation of the gap amount stops.

In this configuration, the filter drive section varies the step voltage to be applied to the gap amount varying section in a stepwise manner at voltage intervals corresponding to the peak detection pitch. At this moment, in the peak detection mode, it is not necessary to detect the accurate value of the light intensity, and it is sufficient that the position of the peak wavelength can be detected. Therefore, it is not necessary for the filter drive section to wait until the fluctuation of the gap amount vanishes after varying the voltage, and it is possible to vary the gap amount continuously by sequentially varying the voltage at predetermined intervals.

Further, in this configuration, the peak detection section detects the local maximum point of the light intensity based on the variation state of the light intensity detected by the detection section, and obtains the voltage set by the filter drive section when the local maximum point is detected to make it possible to easily obtain the step voltage (the peak-corresponding voltage) necessary for taking out the light with the peak wavelength from the variable wavelength interference filter.

It should be noted that since the voltage applied to the gap amount varying section and the gap amount set by applying the voltage are values corresponding to each other, to detect the voltage for taking out the light with the peak wavelength from the variable wavelength interference filter means to detect the peak-corresponding gap.

Further, since in this configuration, the filter drive section varies the voltage to be applied to the gap amount varying section at the voltage intervals corresponding to the peak detection pitch which is smaller than the measurement pitch, it is possible to accurately detect the peak wavelength which cannot be detected using the measurement pitch.

In the spectroscopic measurement device according to the above aspect of the invention, it is preferable that the gap amount varying section varies the gap amount of the gap in accordance with a level of the voltage applied, and when the mode switching section switches the operation mode to the peak detection mode, the filter drive section applies an analog voltage continuously varying to the gap amount varying section.

In this configuration, in the peak detection mode, the filter drive section applies the analog voltage varying continuously to the gap amount varying section to thereby continuously vary the gap amount.

In this case, by monitoring the voltage value applied to the gap amount varying section, and reading the voltage value at the timing when the local maximum point of the light intensity is detected, it is possible to easily obtain the peak-corresponding voltage necessary to take out the light with the peak wavelength from the variable wavelength interference filter.

Further, in this case, since the voltage value to be monitored is a value varying continuously, it is possible to obtain the more accurate peak-corresponding voltage compared to the case of obtaining the peak-corresponding voltage from, for example, the step voltages with constant intervals of a predetermined pitch.

In the spectroscopic measurement device according to the above aspect of the invention, it is preferable that the spectroscopic measurement device further includes a differentiating circuit, the detection section outputs a detection signal corresponding to the light intensity of the light detected, the differentiating circuit performs differential processing on the detection signal, and the peak detection section detects the peak-corresponding gap amount based on the detection signal on which the differential processing is performed by the differentiating circuit.

According to this configuration, the detection signal output from the detection section is input to the differentiating circuit, and the peak wavelength of the measurement object light is detected based on the signal processed by the differentiating circuit. Specifically, the signal variation amount of the detection signal is calculated in the differentiating circuit. Therefore, the peak detection section can easily detect the position of the peak wavelength in the measurement object light by detecting the position where the signal variation amount takes 0.

Another aspect of the invention is directed to a spectroscopic measurement method in the spectroscopic measurement device including a variable wavelength interference filter having a first reflecting film, a second reflecting film opposed to the first reflecting film via a gap of a predetermined gap amount, and a gap amount varying section adapted to vary the gap amount in response to application of the voltage, a detection section adapted to detect the light intensity of the light taken out by the variable wavelength interference filter, and a control section adapted to control the variable wavelength interference filter to measure a dispersion spectrum of measurement object light. The method includes allowing the control section to perform detection of a peak-corresponding gap amount, which is a gap amount for taking out the light with a peak wavelength of the measurement object light using the variable wavelength interference filter, and measurement of the dispersion spectrum of the measurement object light after the peak detection step. In the measurement, the dispersion spectrum is measured by varying the gap amount of the gap to gap amounts with predetermined measurement intervals, and the peak-corresponding gap amount corresponding to the peak wavelength in a stepwise manner, and obtaining the light intensities corresponding to the constant interval gap amounts and the peak-corresponding gap amount.

According to this aspect of the invention, the peak detection step of detecting the peak wavelength of the measurement object light is performed, and then the measurement step is performed. In the measurement step, the gap amount is varied to the constant interval gap amounts at a constant measurement pitch, and the peak-corresponding gap amount corresponding to the peak wavelength thus obtained in a stepwise manner, and the light intensities corresponding respectively to the gap amounts are measured.

Therefore, similarly to the above aspects of the invention, in this aspect of the invention, not only the light intensity of the light taken out in accordance with the constant interval gap amounts, but also the light intensity of the light with the peak wavelength of the measurement object light can be obtained, and it is possible to measure the dispersion spectrum more approximate to the measurement object light.

Further, the prompt measurement can be performed compared to the case of, for example, performing the detailed spectroscopic measurement at a pitch shorter than the measurement pitch.

According to the configuration described above, in this aspect of the invention, it is possible to promptly measure the accurate dispersion spectrum.

### BRIEF DESCRIPTION OF THE DRAWINGS

The invention will be described with reference to the accompanying drawings, wherein like numbers reference like elements.

FIG. 1 is a block diagram showing a schematic configuration of a spectroscopic measurement device according to a first embodiment of the invention.

FIG. 2 is a plan view showing a schematic configuration of a variable wavelength interference filter according to the first embodiment.

FIG. 3 is a cross-sectional view showing a schematic configuration of a variable wavelength interference filter according to the first embodiment.

FIG. 4 is a flowchart showing a spectroscopic measurement method of the spectroscopic measurement device according to the first embodiment.

FIG. 5 is a diagram showing a spectrum curve obtained by the measurement of the spectroscopic measurement device according to the first embodiment.

FIG. 6 is a block diagram showing a schematic configuration of a spectroscopic measurement device according to a second embodiment of the invention.

FIG. 7 is a diagram showing a spectrum curve obtained by the measurement of an existing spectroscopic measurement device.

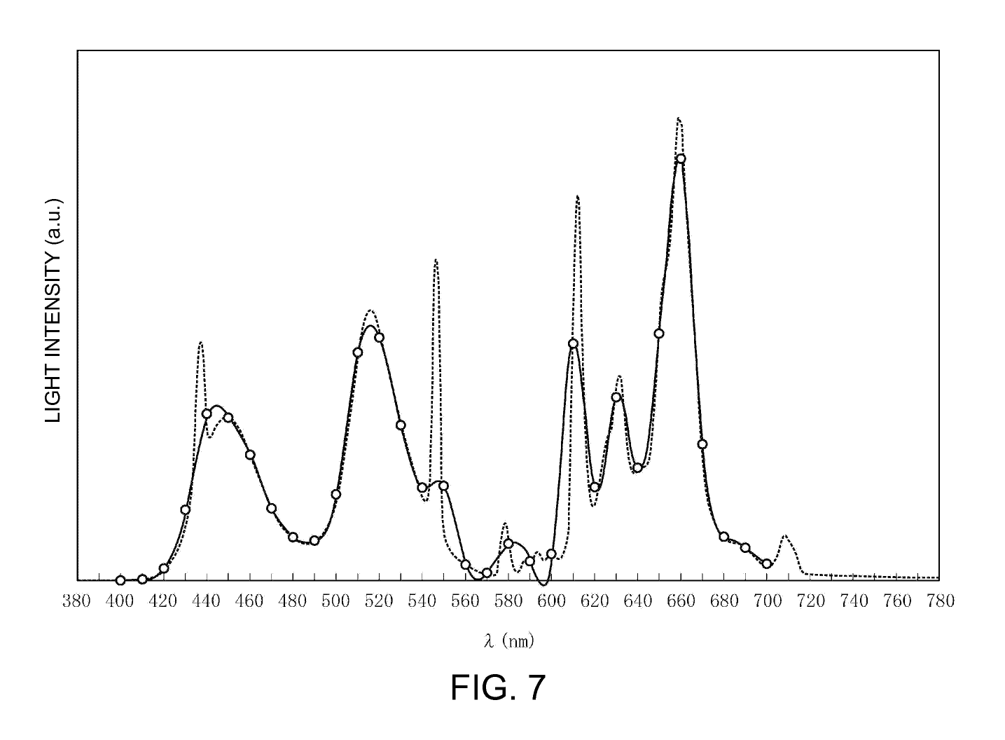

### DESCRIPTION OF EXEMPLARY EMBODIMENTS

### First Embodiment

A first embodiment of the invention will hereinafter be explained with reference to the accompanying drawings.

### Configuration of Spectroscopic Measurement Device

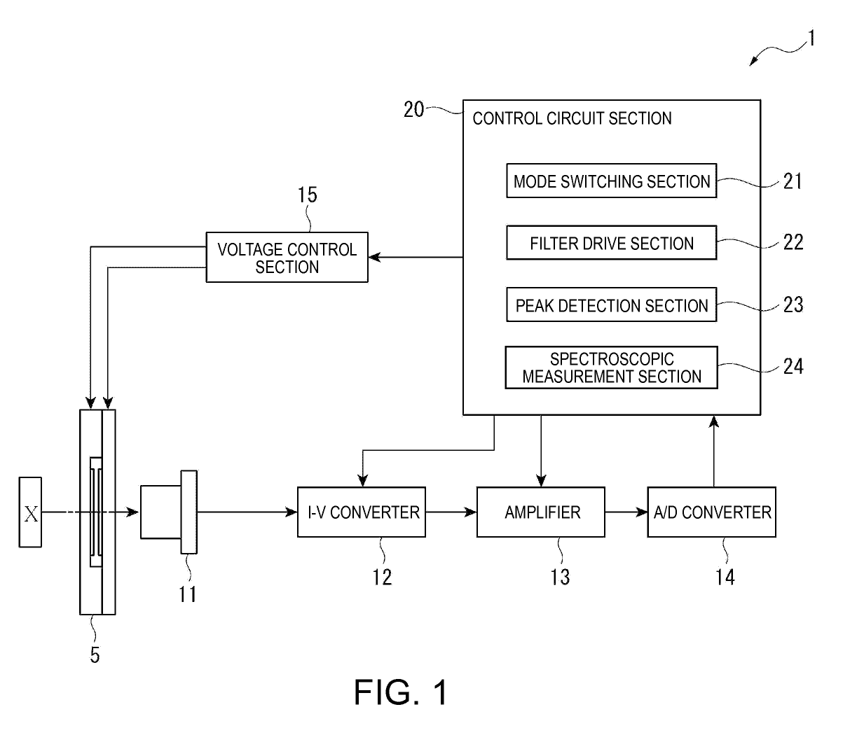

FIG. 1 is a block diagram showing a schematic configuration of a spectroscopic measurement device according to the present embodiment.

The spectroscopic measurement device 1 is a device for analyzing the light intensity of each wavelength in the measurement object light to thereby measure the dispersion spectrum thereof. Further, although the measurement object X is not particularly limited, in the present embodiment, the measurement of the dispersion spectrum can more advantageously performed in particular with respect to light source devices and light emitting elements having a sharp peak wavelength at a specific wavelength.

As shown in FIG. 1, the spectroscopic measurement device 1 is provided with a variable wavelength interference filter 5, a detector 11 (a detection section), an I-V converter 12, an amplifier 13, an A/D converter 14, a voltage control section 15, and a control circuit section 20.

The detector 11 receives the light transmitted through the variable wavelength interference filter 5, and then outputs a detection signal (an electrical current) corresponding to the light intensity of the light thus received.

The I-V converter 12 converts the detection signal input from the detector 11 into a voltage value, and then outputs it to the amplifier 13.

The amplifier 13 amplifies the voltage (the detection voltage) corresponding to the detection signal and input from the I-V converter 12.

The A/D converter 14 converts the detection voltage (an analog signal) input from the amplifier 13 into a digital signal, and then outputs it to the control circuit section 20.

The voltage control section 15 applies a drive voltage to an electrostatic actuator 56, described later, of the variable wavelength interference filter 5 based on the control of the control circuit section 20.

### Configuration of Variable Wavelength Interference Filter

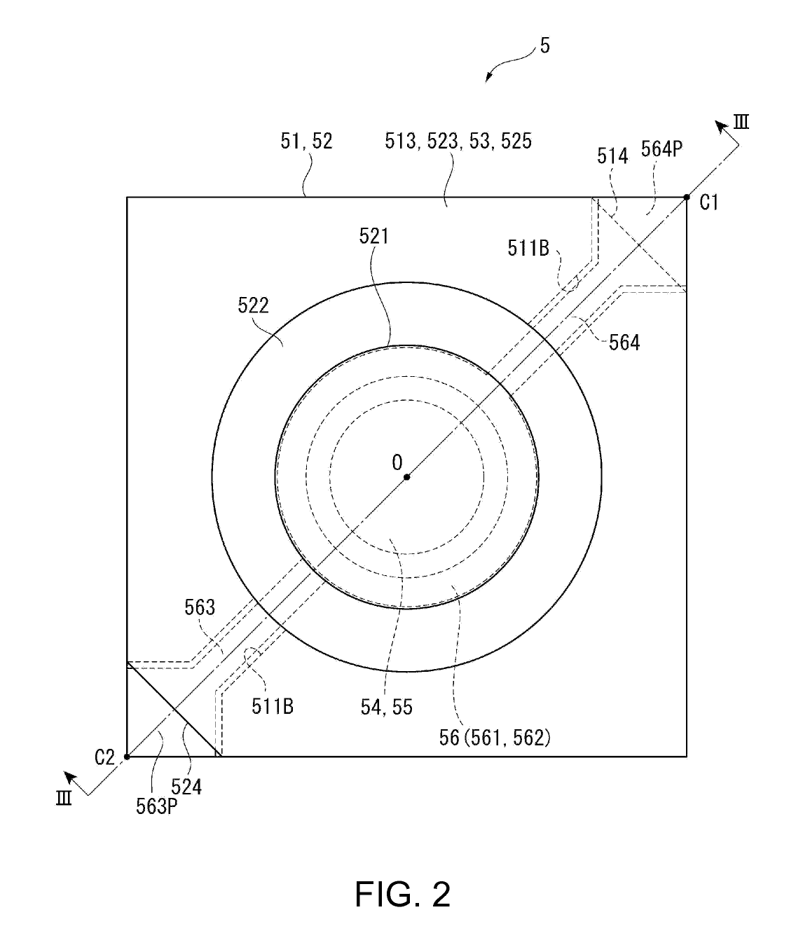

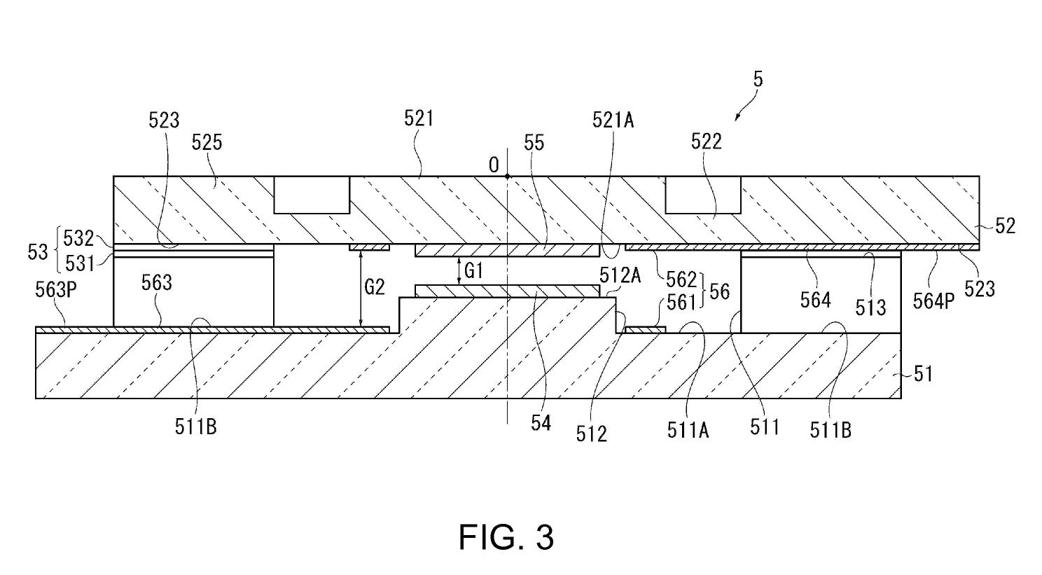

Here, the variable wavelength interference filter 5 to be incorporated in the spectroscopic measurement device 1 will be explained. FIG. 2 is a plan view showing a schematic configuration of the variable wavelength interference filter. FIG. 3 is a cross-sectional view obtained by cutting the variable wavelength interference filter shown in FIG. 2 along the III-III line.

As shown in FIG. 2, the variable wavelength interference filter 5 is an optical member having, for example, a rectangular plate shape. As shown in FIG. 3, the variable wavelength interference filter 5 is provided with a stationary substrate 51 and a movable substrate 52. The stationary substrate 51 and the movable substrate 52 are each made of a variety of types of glass such as soda glass, crystalline glass, quartz glass, lead glass, potassium glass, borosilicate glass, or alkali-free glass, or a quartz crystal, for example. Further, the stationary substrate 51 and the movable substrate 52 are configured integrally by bonding a first bonding section 513 of the stationary substrate 51 and a second bonding section 523 of the movable substrate 52 to each other with bonding films 53 (a first bonding film 531 and a second bonding film 532) each formed of, for example, a plasma polymerization film consisting primary of, for example, siloxane.

The stationary substrate 51 is provided with a stationary reflecting film 54 constituting the first reflecting film according to the invention, and the movable substrate 52 is provided with a movable reflecting film 55 constituting the second reflecting film according to the invention. The stationary reflecting film 54 and the movable reflecting film 55 are disposed so as to be opposed to each other via an inter-reflecting film gap G1 (the gap according to the invention). Further, the variable wavelength interference filter 5 is provided with the electrostatic actuator 56 used for adjusting (varying) the gap amount of the inter-reflecting film gap G1. The electrostatic actuator 56 corresponds to a gap amount varying section according to the invention. The electrostatic actuator 56 is constituted by a stationary electrode 561 provided to the stationary substrate 51 and a movable electrode 562 provided to the movable substrate 52. The stationary electrode 561 and the movable electrode 562 are opposed to each other via an inter-electrode gap G2. Here, there can be adopted a configuration of disposing these electrodes 561, 562 directly on the surfaces of the stationary substrate 51 and the movable substrate 52, respectively, or a configuration of disposing them via other film members. Here, the gap amount of the inter-electrode gap G2 is larger than the gap amount of the inter-reflecting film gap G1.

Further, in a filter plan view shown in FIG. 2 in which the variable wavelength interference filter 5 is viewed from the thickness direction of the stationary substrate 51 (the movable substrate 52), the planar center point O of the stationary substrate 51 and the movable substrate 52 coincides with the center point of the stationary reflecting film 54 and the movable reflecting film 55, and further coincides with the center point of a movable section 521 described later.

It should be noted that in the explanation below, the plan view from the thickness direction of the stationary substrate 51 or the movable substrate 52, namely the plan view of the variable wavelength interference filter 5 viewed from the stacking direction of the stationary substrate 51, the bonding film 53, and the movable substrate 52, is referred to as the filter plan view.

### Configuration of Stationary Substrate

The stationary substrate 51 is provided with an electrode arrangement groove 511 and a reflecting film installation section 512 formed by etching. The stationary substrate 51 is formed to have a thickness dimension larger than that of the movable substrate 52, and there is no deflection of the stationary substrate 51 due to the electrostatic attractive force when applying a voltage between the stationary electrode 561 and the movable electrode 562, or the internal stress of the stationary electrode 561.

Further, a vertex C1 of the stationary substrate 51 is provided with a cutout section 514, and a movable electrode pad 564P described later is exposed on the stationary substrate 51 side of the variable wavelength interference filter 5.

The electrode arrangement groove 511 is formed to have a ring-like shape cantered on the planar center point O of the stationary substrate 51 in the filter plan view. The reflecting film installation section 512 is formed so as to protrude toward the movable substrate 52 from the central portion of the electrode arrangement groove 511 in the plan view described above. The bottom surface of the electrode arrangement groove 511 forms an electrode installation surface 511A on which the stationary electrode 561 is disposed. Further, the projection tip surface of the reflecting film installation section 512 forms a reflecting film installation surface 512A.

Further, the stationary substrate 51 is provided with electrode extraction grooves 511B respectively extending from the electrode arrangement groove 511 toward the vertexes C1, C2 of the outer peripheral edge of the stationary substrate 51.

The electrode installation surface 511A of the electrode arrangement groove 511 is provided with the stationary electrode 561. More specifically, the stationary electrode 561 is disposed in an area of the electrode installation surface 511A, the area being opposed to the movable electrode 562 of the movable section 521 described later. Further, it is also possible to adopt the configuration in which an insulating film for providing an insulation property between the stationary electrode 561 and the movable electrode 562 is stacked on the stationary electrode 561.

Further, the stationary substrate 51 is provided with a stationary extraction electrode 563 extending from the outer peripheral edge of the stationary electrode 561 toward the vertex C2. The extending tip portion (a part located at the vertex C2 of the stationary substrate 51) of the stationary extraction electrode 563 forms a stationary electrode pad 563P connected to the voltage control section 15.

It should be noted that although in the present embodiment there is shown a configuration of providing the single stationary electrode 561 to the electrode installation surface 511A, it is also possible to adopt, for example, a configuration (a dual electrode structure) having two concentric electrodes centered on the planar center point O.

As described above, the reflecting film installation section 512 is formed to have a roughly columnar shape coaxial with the electrode arrangement groove 511 and having a diameter smaller than that of the electrode arrangement groove 511, and is provided with the reflecting film installation surface 512A opposed to the movable substrate 52.

As shown in FIG. 3, the stationary reflecting film 54 is installed in the reflecting film installation section 512. As the stationary reflecting film 54, a metal film made of, for example, Ag, or an alloy film made of, for example, an Ag alloy can be used. Further, it is also possible to use a dielectric multilayer film with a high refractive index layer made of, for example, TiO₂, and a low refractive index layer made of, for example, SiO₂. Further, it is also possible to use a reflecting film obtained by stacking a metal film (or an alloy film) on a dielectric multilayer film, a reflecting film obtained by stacking a dielectric multilayer film on a metal film (or an alloy film), a reflecting film obtained by laminating a single refractive layer (made of, e.g., TiO₂ or SiO₂) and a metal film (or an alloy film) with each other, and so on.

Further, it is also possible to form an antireflection film on the light entrance surface (the surface not provided with the stationary reflecting film 54) of the stationary substrate 51 at a position corresponding to the stationary reflecting film 54. The antireflection film can be formed by alternately stacking low refractive index films and high refractive index films, decreases the reflectance of the visible light on the surface of the stationary substrate 51, and increases the transmittance thereof.

Further, the surface of the stationary substrate 51, which is opposed to the movable substrate 52, and on which the electrode arrangement groove 511, the reflecting film installation section 512, and the electrode extraction grooves 511B are not formed by etching, constitutes a first bonding section 513. The first bonding section 513 is provided with a first bonding film 531, and by bonding the first bonding film 531 to a second bonding film 532 provided to the movable substrate 52, the stationary substrate 51 and the movable substrate 52 are bonded to each other as described above.

### Configuration of Movable Substrate

The movable substrate 52 is provided with the movable section 521 having a circular shape centered on the planar center point O, a holding section 522 coaxial with the movable section 521 and for holding the movable section 521, and a substrate peripheral section 525 disposed on the outer side of the holding section 522 in the filter plan view shown in FIG. 2.

Further, as shown in FIG. 2, in the movable substrate 52, there is formed a cutout section 524 so as to correspond to the vertex C2, and when viewing the variable wavelength filter 5 from the movable substrate 52 side, the stationary electrode pad 563P is exposed.

The movable section 521 is formed to have a thickness dimension larger than that of the holding section 522, and is formed in the present embodiment, for example, to have the same thickness dimension as that of the movable substrate 52. The movable section 521 is formed to have a diameter larger than at least the diameter of the outer peripheral edge of the reflecting film installation surface 512A in the filter plan view. Further, the movable section 521 is provided with the movable electrode 562 and the movable reflecting film 55.

It should be noted that it is also possible to form an antireflection film on the opposite surface of the movable section 521 to the stationary substrate 51 similarly to the case of the stationary substrate 51. Such an antireflection film can be formed by alternately stacking low refractive index films and high refractive index films, and is capable of decreasing the reflectance of the visible light on the surface of the movable substrate 52, and increasing the transmittance thereof.

The movable electrode 562 is opposed to the stationary electrode 561 via the inter-electrode gap G2, and is formed to have a ring-like shape, which is the same shape as that of the stationary electrode 561. Further, the movable substrate 52 is provided with a movable extraction electrode 564 extending from the outer peripheral edge of the movable electrode 562 toward the vertex C1 of the movable substrate 52. The extending tip portion (a part located at the vertex C1 of the movable substrate 52) of the movable extraction electrode 564 forms a movable electrode pad 564P to be connected to the voltage control section 15.

The movable reflecting film 55 is disposed at the central portion of a movable surface 521A of the movable section 521 so as to be opposed to the stationary reflecting film 54 via the inter-reflecting film gap G1. As the movable reflecting film 55, a reflecting film having the same configuration as that of the stationary reflecting film 54 described above is used.

It should be noted that in the present embodiment, although the example in which the gap amount of the inter-electrode gap G2 is larger than the gap amount of the inter-reflecting film gap G1 is shown as described above, the invention is not limited thereto. It is also possible to adopt a configuration in which the gap amount of the inter-reflecting film gap G1 is larger than the gap amount of the inter-electrode gap G2 depending on the wavelength band of the measurement object light in the case of using, for example, an infrared beam or a far infrared beam as the measurement object light.

The holding section 522 is a diaphragm surrounding the periphery of the movable section 521, and is formed to have a thickness dimension smaller than that of the movable section 521. Such a holding section 522 is easier to be deflected than the movable section 521, and it becomes possible to displace the movable section 521 toward the stationary substrate 51 with a weak electrostatic attractive force. On this occasion, since the movable section 521 has a larger thickness dimension and higher rigidity than those of the holding section 522, the shape variation of the movable section 521 does not occur even in the case in which the holding section 522 is pulled toward the stationary substrate 51 due to the electrostatic attractive force. Therefore, deflection of the movable reflecting film 55 provided to the movable section 521 does not occur, and it becomes possible to always keep the stationary reflecting film 54 and the movable reflecting film 55 in a parallel state.

It should be noted that although in the present embodiment, the holding section 522 having a diaphragm shape is shown as an example, the shape is not limited thereto, but a configuration of, for example, providing beam-like holding sections arranged at regular angular intervals centered on the planar center point O can also be adopted.

As described above, the substrate peripheral section 525 is disposed on the outer side of the holding section 522 in the filter plan view. The surface of the substrate peripheral section 525 opposed to the stationary substrate 51 is provided with the second bonding section 523 opposed to the first bonding section 513. Further, the second bonding section 523 is provided with the second bonding film 532, and as described above, by bonding the second bonding film 532 to the first bonding film 531, the stationary substrate 51 and the movable substrate 52 are bonded to each other.

In the variable wavelength interference filter 5 described hereinabove, the stationary pad 563P and the movable pad 564P are connected respectively to the voltage control section 15. Therefore, by the voltage control section 15 applying a voltage between the stationary electrode 561 and the movable electrode 562, the movable section 521 is displaced toward the stationary substrate 51 due to the electrostatic attractive force. Thus, it becomes possible to vary the gap amount of the inter-reflecting film gap G1 to a predetermined amount.

### Configuration of Control Circuit Section

Going back to FIG. 1, the control circuit section 20 of the spectroscopic measurement device 1 will be explained.

The control circuit section 20 is configured by combining, for example, a CPU and a memory, and controls the overall operation of the spectroscopic measurement device 1. As shown in FIG. 1, the control circuit section 20 is provided with a mode switching section 21, a filter drive section 22, a peak detection section 23, and a spectroscopic measurement section 24.

The mode switching section 21 switches the operation mode in the spectroscopic measurement device 1. Specifically, the mode switching section 21 switches the operation mode to one of a peak detection mode and a measurement mode.

The peak detection mode is an operation mode for detecting one of the peak wavelength of the measurement object light, the gap amount (a peak-corresponding gap amount) of the inter-reflecting film gap G1 necessary for making the light with the peak wavelength be transmitted from the variable wavelength interference filter 5, and the drive voltage (a peak-corresponding voltage) applied to the electrostatic actuator for setting the peak-corresponding gap amount.

The measurement mode is an operation mode for measuring the dispersion spectrum based on the light intensity of each wavelength of the measurement object light.

Here, when the measurement process of the dispersion spectrum of the measurement object X by the spectroscopic measurement device 1 is started, the mode switching section 21 firstly switches the operation mode to the peak detection mode, and when the peak detection mode is terminated, the mode switching section 21 then switches the operation mode to the measurement mode.

The filter drive section 22 sets the drive voltage to be applied to the electrostatic actuator 56 of the variable wavelength interference filter 5. Further, the mode switching section 21 controls the voltage control section 15 to apply the drive voltage thus set to the electrostatic actuator 56 to thereby vary the gap amount of the inter-reflecting film gap G1.

At this moment, if the operation mode is set to the peak detection mode, the filter drive section 22 varies the voltage to be applied to the electrostatic actuator 56 in a stepwise manner at predetermined voltage intervals. Here, the voltage intervals are set to the intervals corresponding to the case of varying the gap amount of the inter-reflecting film gap G1 at a constant peak detection pitch. The peak detection pitch is set to, for example, a value in a range of 0.5 nm through 2.5 nm (the measured wavelength intervals are in a range of 1 nm through 5.0 nm), which corresponds to sufficiently small intervals with respect to a measurement pitch described later.

Further, in the peak detection mode, it is sufficient to find out the peak position in the measurement object light, and therefore, it is not necessary to wait until the vibration of the movable section 521 stops in each of the steps when varying the applied voltage (the step voltage) to the electrostatic actuator 56 in a stepwise manner. In other words, the filter drive section 22 sequentially varies the step voltage to be applied to the electrostatic actuator 56 at regular velocity intervals to thereby continuously vary the gap amount.

On the other hand, if the operation mode is the measurement mode, the filter drive section 22 varies the gap amount of the inter-reflecting film gap G1 to the constant interval gap amounts set at the measurement pitch and the gap amount (the peak-corresponding gap amount) corresponding to the peak wavelength detected in the peak detection mode in a stepwise manner. In this case, since it is necessary to detect the light intensity with high accuracy by the detector 11, the filter drive section 22 waits until the vibration of the movable section 521 stops and the gap amount is stabilized every time the gap amount is varied. Then, when the light intensity is measured, the gap amount of the inter-reflecting film gap G1 is set to the next one of set gap amounts (the constant interval gap amounts or the peak-corresponding gap amount).

If the operation mode is the peak detection mode, the peak detection section 23 detects the peak wavelength based on the variation state of the light intensity detected by the detector 11. Subsequently, in order to take out the light with the peak wavelength from the variable wavelength interference filter 5, the peak detection section 23 detects the drive voltage (the peak-corresponding voltage) to be applied to the electrostatic actuator 56.

Specifically, the peak detection section 23 detects the position (the position of the peak wavelength) of the local maximum point based on the variation state of the light intensity detected by the detector 11. Then, the peak detection section 23 obtains the drive voltage (the peak-corresponding voltage) applied to the electrostatic actuator 56 when the local maximum point is detected.

It should be noted that the drive voltage applied to the electrostatic actuator 56 and the gap amount of the inter-reflecting film gap G1 are in a one-to-one relationship, and have the values corresponding to each other. Therefore, the fact that the peak detection section 23 detects the peak-corresponding drive voltage means that the peak detection section 23 obtains the peak-corresponding gap amount corresponding to the peak wavelength.

Further, although in the present embodiment, the peak wavelength is detected based on the variation state of the light intensity and the peak-corresponding drive voltage is obtained based on the applied voltage to the electrostatic actuator 56 when the peak wavelength is detected, the invention is not limited thereto.

For example, a capacitance detecting electrode for detecting the capacitance held between the stationary reflecting film 54 and the movable reflecting film 55 of the variable wavelength interference filter 5 is provided, and the peak detection section 23 detects the peak-corresponding gap amount based on the output value of the capacitance detecting electrode. Then, it is also possible for the peak detection section 23 to obtain the peak-corresponding drive voltage based on the V-λ relation data (the relation data between the drive voltage and the gap amount (the transmission wavelength)) stored in, for example, a memory.

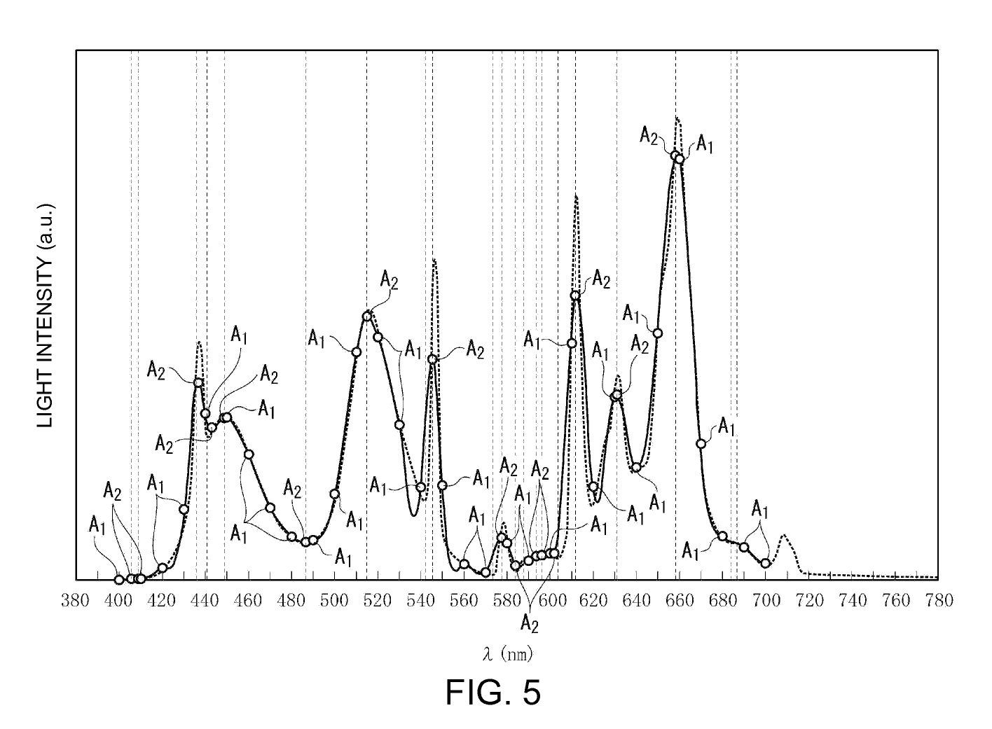

If the operation mode is set to the measurement mode, the spectroscopic measurement section 24 obtains the light intensity corresponding to each of the set gap amounts set by the filter drive section 22, and then measures the dispersion spectrum. Further, it is also possible for the spectroscopic measurement section 24 to create the spectrum curve (see, e.g., FIG. 5) based on the measurement result.

### Spectroscopic Measurement Method by Spectroscopic Measurement Device

Then, a spectroscopic measurement method using the spectroscopic measurement device 1 described above will be explained with reference to the drawings.

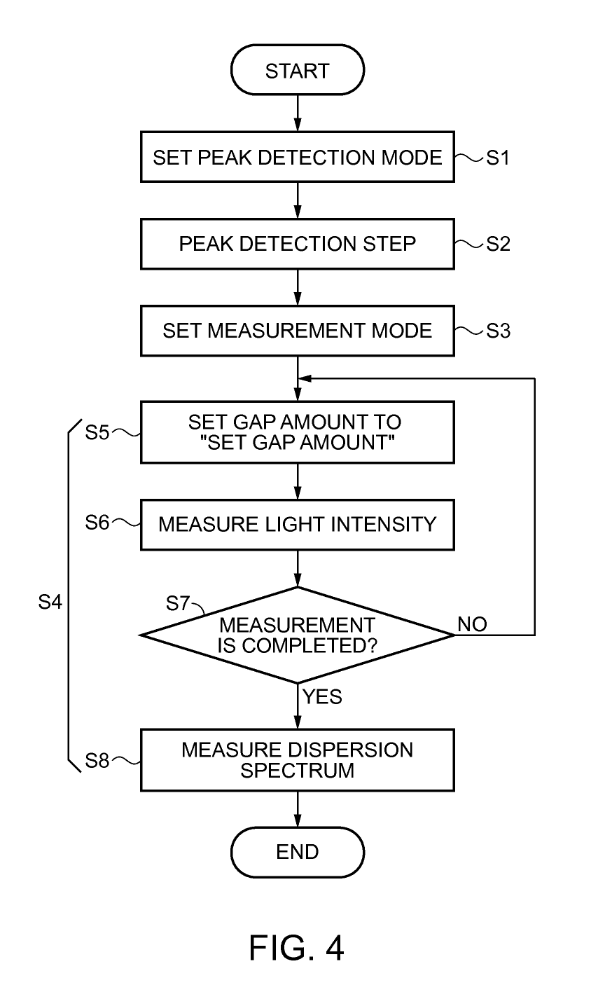

FIG. 4 is a flowchart of the spectroscopic measurement method according to the present embodiment. FIG. 5 is a diagram showing the spectrum curve obtained by the measurement.

As shown in FIG. 4, in the spectroscopic measurement method according to the present embodiment, when the measurement is started, the mode switching section 21 firstly sets (S1) the operation mode to the peak detection mode.

When the operation mode is set to the peak detection mode in the step S1, the control circuit section 20 performs (S2) the peak detection step of varying the gap amount of the inter-reflecting film gap G1 and detecting the peak-corresponding voltage.

In the peak detection step of the step S2, the filter drive section 22 controls the voltage control section 15 to vary the voltage to be applied to the electrostatic actuator 56 of the variable wavelength interference filter 5 in a stepwise manner. At this moment, the filter drive section 22 sets the drive voltage to be applied to the electrostatic actuator 56 so that the gap amount of the inter-reflecting film gap G1 varies in a stepwise manner at a predetermined peak detection pitch (e.g., 1 nm). It should be noted that it is possible to previously measure the values of the drive voltage to be applied to the electrostatic actuator 56 in, for example, the manufacturing process of the spectroscopic measurement device 1, and then store them in the storage section such as a memory.

Further, at this moment, the filter drive section 22 sequentially varies the voltage to thereby vary the gap amount without waiting until the gap amount is settled to a stable value. In other words, the filter drive section 22 continuously displaces (performs a sweep operation with) the movable section 521 at a constant speed.

As described above, when varying the gap amount of the inter-reflecting film gap G1, the wavelength of the light transmitted through the variable wavelength interference filter 5 also varies in accordance with the gap amount of the inter-reflecting film gap G1. The transmitted light is received by the detector 11, and the detection signal corresponding to the light intensity is input to the control circuit section 20 from the detector 11 via the I-V converter 12, the amplifier 13, and the A/D converter 14.

Subsequently, the peak detection section 23 detects the local maximum point from the variation in the light intensity in every peak detection pitch based on the detection signal thus input, and obtains the drive voltage (the peak-corresponding voltage) applied to the electrostatic actuator when the local maximum point is detected. It should be noted that it is also possible for the peak detection section 23 to detect not only the local maximum point but also a local minimum point.

After the process of the step S2, the mode switching section 21 switches (S3) the operation mode of the spectroscopic measurement device 1 to the measurement mode.

Thus, the control circuit section 20 performs (S4) the measurement step. In the measurement step of the step S4, the filter drive section 22 controls the voltage control section 15 to apply the drive voltage corresponding to one of the set gap amounts to the electrostatic actuator 56 to thereby set (S5) the gap amount of the inter-reflecting film gap G1 to the set gap amount. The set gap amounts include the peak-corresponding gap amount corresponding to the peak-corresponding voltage obtained in the step S2 and the constant interval gap amounts corresponding to the gap amounts set at a predetermined measurement pitch (e.g., 5 nm) based on the initial gap amount of the inter-reflecting film gap G1. It should be noted that it is also possible to add the gap amount corresponding to the local minimum point to the set gap amounts if the local minimum point is detected in the step S2 in addition to the local maximum point in the variation in the light intensity. As the drive voltage corresponding to the gap amount at the local minimum point, the drive voltage applied when the local minimum point is obtained in the step S2 can be set.

Then, the filter drive section 22 applies the drive voltages (the step voltages) corresponding respectively to the set gap amounts to the electrostatic actuator 56 in the ascending order of the voltage value (the descending order of the set gap amount).

Further, since it is necessary to measure the light intensity in the light with the wavelength corresponding to the set gap amount with high accuracy in the measurement mode, the filter drive section 22 waits for the time (the stabilization time) until the movable section 521 stops and the variation in the gap amount of the inter-reflecting film gap G1 vanishes after switching the drive voltage to be applied to the electrostatic actuator 56. The stabilization time can be set for each of the gap amounts to be set, or the time until the movable section 521 stops when displacing the movable section 521 the maximum amount from the initial state can be set as the stabilization time.

Then, after the stabilization time described above has elapsed, the spectroscopic measurement section 24 measures (S6) the light intensity detected by the detector 11. Further, the spectroscopic measurement section 24 stores the light intensity thus measured and the drive voltage (or the set gap amount corresponding to the drive voltage, or the wavelength of the light emitted from the variable wavelength interference filter 5 in accordance with the set gap amount) corresponding to the light intensity in conjunction with each other in a storage section such as a memory.

Subsequently, the control circuit section 20 determines (S7) whether or not the measurement is completed. In other words, whether or not the measurement of the light intensity corresponding to all of the set gap amounts has been completed is determined.

If “NO” is determined in the step S7, the process returns to the step S5, and the filter drive section 22 applies the drive voltage corresponding to the next set gap amount to the electrostatic actuator 56.

On the other hand, if “YES” is determined in the step S7, the spectroscopic measurement section 24 measures the dispersion spectrum of the measurement object light based on the light intensity obtained in accordance with each of the set gap amounts. It should be noted that it is also possible for the filter drive section 22 to generate such a spectrum curve as shown in FIG. 5.

In the spectroscopic measurement device 1 according to the present embodiment, by performing such a spectroscopic measurement method as described above, it becomes possible to also detect the light intensity (A₂ in FIG. 5) of each of the peak wavelengths of the measurement object light in addition to the light intensity (A₁ in FIG. 5) at the wavelength intervals (e.g., the intervals of 10 nm) corresponding to the constant interval gap amount. Therefore, even in the case in which the peak wavelength of the measurement object light exists, for example, in between the wavelengths corresponding to the constant interval gap amounts, it is possible to detect the peak wavelength of the measurement object light, and it is possible to obtain the measurement result with little error with respect to the actual dispersion spectrum of the measurement object light.

### Functions and Advantages of Embodiment

In the present embodiment, firstly the mode switching section 21 switches the operation mode to the peak detection mode in the spectroscopic measurement process to thereby perform the peak detection step. In the peak detection step, the filter drive section 22 performs the sweep with the movable section 521 of the variable wavelength interference filter 5 to thereby vary the gap amount of the inter-reflecting film gap G1. Then, the peak detection section 23 detects the local maximum point from the variation state of the light intensity of the measurement object light based on the detection signal output from the detector 11, and then detects the peak-corresponding voltage (the peak-corresponding gap amount) corresponding to the local maximum point.

Then, when the peak detection step is terminated, the mode switching section 21 switches the operation mode to the measurement mode, and the control circuit section 20 performs the measurement step. In the measurement step, the filter drive section 22 switches the voltage to be applied to the electrostatic actuator 56 to the drive voltages corresponding respectively to the constant interval gap amounts set at a predetermined measurement pitch and the peak-corresponding voltage detected in the peak detection step in a stepwise manner, and the spectroscopic measurement section 24 measures the light intensity when applying each of the drive voltages.

Therefore, in the measurement step, the light intensity corresponding to the peak wavelength of the measurement object light can be measured in addition to the light intensity at every predetermined wavelength interval, and it is possible to obtain the measurement result approximate to the actual dispersion spectrum of the measurement object.

In particular in the light emitting elements having a sharp peak wavelength at the specific wavelength, the peak wavelength exists in between the measured wavelengths in some cases. In such cases, it is not achievable to measure the accurate light intensity with respect to the peak wavelength by the measurement of the light intensity at the measured wavelengths with regular intervals. In contrast, according to the spectroscopic measurement device 1 described above, the measurement with high accuracy can be performed with respect to such a measurement object light having the strong peak at a specific wavelength as described above.

Further, in the measurement step, since the number of times of the measurement of the light intensity is reduced compared to the case of varying the gap amount at minute intervals such as 1 nm, the time necessary for the measurement can be reduced accordingly.

According to the configuration described above, in the present embodiment, it is possible to promptly measure the accurate dispersion spectrum.

Further, in the peak detection step, the filter drive section 22 sequentially switches the step voltage to be applied to the electrostatic actuator 56 at voltage intervals corresponding to the peak detection pitch smaller than the measurement pitch to thereby continuously vary the gap amount of the inter-reflecting film gap G1.

By continuously varying the gap amount as described above, the time necessary for the peak detection step can be reduced compared to the case of, for example, detecting the light intensity after stopping the movable section 521 at the peak detection pitch, which makes a contribution to reduction of the time of the overall spectroscopic measurement process.

Further, the peak detection section 23 can detect presence or absence of the local maximum point at the peak detection pitch corresponding to the intervals shorter than the measurement pitch, and is therefore capable of accurately detecting even the peak wavelength located in between the wavelengths corresponding to the measurement pitch. Further, since the step voltage applied to the electrostatic actuator 56 when the local maximum point is detected corresponds to the peak-corresponding voltage, the peak detection section 23 can easily detect the peak-corresponding voltage when the local maximum point is detected, which can achieve speeding up of the process in the peak detection step.

Although in the embodiments described above, it is assumed that the local maximum point is detected, it is also possible to detect a local minimum point similarly.

### Second Embodiment

Then, a second embodiment of the invention will be explained with reference to the accompanying drawings.

In the first embodiment described above, the drive voltage (the step voltage) is applied to the electrostatic actuator 56 in the peak detection step so that the gap amount of the inter-reflecting film gap G1 varies at the peak detection pitch. In contrast, in the second embodiment, an analog voltage for continuously varying the gap amount of the inter-reflecting film gap G1 is applied in the peak detection step, which is the difference from the first embodiment described above.

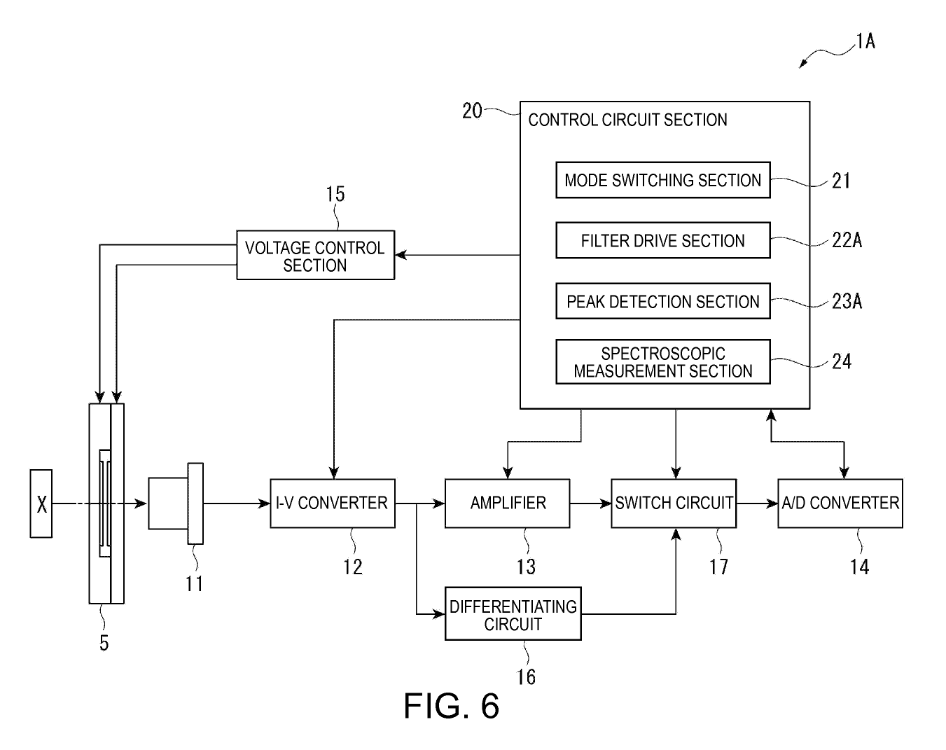

FIG. 6 is a block diagram showing a schematic configuration of the spectroscopic measurement device 1A according to the second embodiment. It should be noted that the constituents substantially the same as those of the first embodiment described above are denoted by the same reference symbols, and the explanation therefor will be omitted.

As shown in FIG. 6, the spectroscopic measurement device 1A according to the present embodiment is provided with the variable wavelength interference filter 5, the detector 11, the I-V converter 12, the amplifier 13, the A/D converter 14, the voltage control section 15, a differentiating circuit 16, a switch circuit 17, and the control circuit section 20.

The differentiating circuit 16 differentiates the detection signal input from the I-V converter 12. In other words, the processed signal output from the differentiating circuit 16 is the signal representing the variation amount of the detection signal.

The switch circuit 17 switches the signal to be passed to the A/D converter 14 in accordance with the operation mode set by the mode switching section 21. Specifically, when the mode switching section 21 switches the operation mode to the peak detection mode, the switch circuit 17 outputs the processed signal input from the differentiating circuit 16 to the A/D converter 14. On the other hand, when the mode switching section 21 switches the operation mode to the measurement mode, the switch circuit 17 outputs the detection signal amplified by the amplifier 13 to the A/D converter 14.

Further, the voltage control section 15 is provided with a voltmeter (not shown) for monitoring the voltage applied to the electrostatic actuator 56.

Further, if the peak detection mode is set by the mode switching section 21, the filter drive section 22A of the control circuit section 20 controls the voltage control section 15 to apply the analog voltage varying continuously to the electrostatic actuator 56 of the variable wavelength interference filter 5.

It should be noted that if the measurement mode is set by the mode switching section 21, the filter drive section 22A performs substantially the same process as that of the filter drive section 22 of the first embodiment described above.

The peak detection section 23A detects the local maximum points and the local minimum points in the detection signal based on the processed signal processed by the differentiating circuit 16. In other words, the processed signal output from the differentiating circuit 16 is the signal representing the variation amount of the detection signal. Therefore, by detecting the point at which the value of the processed signal is “0,” the peak detection section 23A can easily detect the local maximum points and the local minimum points.

Then, the peak detection section 23A obtains the value of the voltmeter of the voltage control section 15 when the local maximum point or the local minimum point is detected as the peak-corresponding voltage.

In the spectroscopic measurement device 1A according to the second embodiment described above, the dispersion spectrum can be measured using substantially the same spectroscopic measurement process (FIG. 4) as that of the spectroscopic measurement device 1 according to the first embodiment.

Specifically, in the spectroscopic measurement device 1A according to the present embodiment, when the mode switching section 21 switches the operation mode to the peak detection mode in the step S1, the switch circuit 17 performs switching so as to output the processed signal input from the differentiating circuit 16 to the control circuit section 20 via the A/D converter 14.

Then, in the peak detection step in the step S2, the filter drive section 22A controls the voltage control section 15 to apply the analog voltage to the electrostatic actuator as described above. Thus, the gap amount of the inter-reflecting film gap G1 varies continuously, and the wavelength of the transmitted light transmitted through the variable wavelength interference filter 5 also varies continuously.

Therefore, the detection signal output from the detector 11 becomes also the detection signal varying continuously, and by inputting the detection signal into the differentiating circuit 16, the processed signal taking “0” at the local maximum points and the local minimum points can be generated.

Then, the peak detection section 23A detects the local maximum points and the local minimum points based on the processed signal, and then measures the applied voltages to the electrostatic actuator 56 when the local maximum points and the local minimum points are detected to thereby obtain the peak-corresponding voltages.

Subsequently, when the mode switching section 21 switches the operation mode to the measurement mode in the step S3, the switch circuit 17 performs switching so as to output the detection signal input from the amplifier 13 to the control circuit section 20 via the A/D converter 14.

Subsequently, the control circuit section 20 performs the measurement step of the step S4 (S5 through S8) similarly to the case of the first embodiment described above.

### Functions and Advantages of Embodiment

In the spectroscopic measurement device 1A according to the present embodiment, in the peak detection step, the filter drive section 22A applies the analog voltage varying continuously to the electrostatic actuator 56, and the peak detection section 23A obtains the peak-corresponding voltages corresponding to the local maximum points and the local minimum points based on the processed signal on which the differential processing is performed by the differentiating circuit 16. In such a configuration, the position of the peak wavelength can more accurately be detected compared to the case of varying the gap amount of the inter-reflecting film gap G1 at the peak detection pitch.

In other words, since the peak-corresponding voltage detected in the first embodiment is one of the values with the voltage intervals corresponding to the peak detection pitch, the peak wavelength detected and the actual peak wavelength of the measurement object light are slightly shifted from each other in some cases depending on the pitch width of the peak detection pitch. In contrast, in the present embodiment, the voltage value at the time point when the local maximum point or the local minimum point of the detection signal is detected out of the analog voltage varying continuously is measured, and set the voltage value to the peak-corresponding voltage. Therefore, it is possible to more accurately detect the peak-corresponding voltage (or the peak-corresponding gap amount) for taking out the light with the peak wavelength by the variable wavelength interference filter 5. Therefore, it is possible to measure the accurate dispersion spectrum with less error can be measured as the dispersion spectrum measured by the measurement step.

Further, the peak detection section 23A detects the local maximum points and the local minimum points in the detection signal based on the processed signal on which the differential processing is performed by the differentiating circuit 16. In this case, it is sufficient for the peak detection section 23A to determine whether or not the signal value is “0,” and the peak detection section 23A can easily perform the detection of the local maximum points and the local minimum points.

### Modified Examples

It should be noted that the invention is not limited to the embodiments described above, but includes modifications, improvements, and so on within a range where the advantages of the invention can be achieved.

For example, although in the embodiments described above, it is assumed that the gap amount of the gap G1 is varied continuously in the peak detection step, it is also possible to provide a predetermined standby time when the gap amount is varied at the peak detection pitch, and vary the gap amount in a stepwise manner. Also in this case, since it is sufficient to detect the local maximum point of the light intensity in the peak detection step, it is not necessary to measure the accurate light intensity, and it becomes possible to perform the process in a shorter period of time compared to the ordinary measurement process of the light intensity.

Although the electrostatic actuator 56 for varying the gap amount of the inter-reflecting film gap G1 due to the electrostatic attractive force caused by applying the voltage is exemplified as the gap amount varying section of the variable wavelength interference filter 5 in the embodiments described above, the invention is not limited thereto.

It is also possible to adopt a configuration of, for example, using a dielectric actuator disposing a first dielectric coil instead of the stationary electrode 561, and disposing a second dielectric coil or a permanent magnet instead of the movable electrode 562.

Further, it is also possible to adopt a configuration of using a piezoelectric actuator instead of the electrostatic actuator 56. In this case, for example, a lower electrode layer, a piezoelectric film, and an upper electrode layer are disposed on the holding section 522 in a stacked manner, and the voltage applied between the lower electrode layer and the upper electrode layer is varied as an input value, and thus the piezoelectric film is expanded or contracted to thereby make it possible to deflect the holding section 522.

Further, it is also possible to use, for example, a variable wavelength interference filter forming the space between the stationary substrate 51 and the movable substrate 52 as an enclosed space, and varying the gap amount of the inter-reflecting film gap G1 by varying the air pressure inside the enclosed space. In this case, the pressure of the air in the enclosed space is increased or decreased using, for example, a pump, and it is possible to perform substantially the same operation as in the embodiments described above by varying the voltage when driving the pump using the filter drive section 22 and the voltage control section 15.

Besides the above, specific structures to be adopted when putting the invention into practice can arbitrarily be replaced with other structures and so on within the range in which the advantages of the invention can be achieved.

The entire disclosure of Japanese Patent Application No. 2011-203285, filed Sep. 16, 2011 is expressly incorporated by reference herein.

What is claimed is:

1. A spectroscopic measurement device comprising:
a variable wavelength interference filter having
a first reflecting film adapted to partially reflect measurement object light incident to the first reflecting film and partially transmit the measurement object light,
a second reflecting film opposed to the first reflecting film across a gap of a predetermined gap amount, and adapted to partially reflect the measurement object light incident to the second reflecting film and partially transmit the measurement object light, and
a gap amount varying section adapted to vary the gap amount;
a detection section adapted to measure a light intensity of the measurement object light transmitted through the variable wavelength interference filter; and
a control section having
a peak detection section adapted to detect a peak-corresponding gap amount, which is a gap amount when the light intensity of the measurement object light transmitted through the variable wavelength interference filter shows a local maximum point,
a filter drive section adapted to control the gap amount varying section to set the gap amount of the gap, and
a spectroscopic analysis section adapted to obtain the light intensity detected by the detection section and obtain dispersion spectrum,
wherein the filter drive section sets the gap amount of the gap to gap amounts with predetermined measurement intervals and the peak-corresponding gap amount, and
the spectroscopic analysis section obtains light intensities corresponding respectively to the gap amounts with the predetermined measurement intervals and the peak-corresponding gap amount.

2. The spectroscopic measurement device according to claim 1, further comprising:
a mode switching section adapted to switch an operation mode of the spectroscopic measurement device to one of a peak detection mode of detecting the peak-corresponding gap amount, and a measurement mode of measuring the dispersion spectrum of the measurement object light,
wherein when the mode switching section switches the operation mode to the peak detection mode,
the filter drive section continuously varies the gap amount of the gap, and
the peak detection section detects a local maximum point of the light intensity based on a variation state of the light intensity detected by the detection section, and detects the gap amount, which is set by the filter drive section when the local maximum point is detected, as the peak-corresponding gap amount.

3. The spectroscopic measurement device according to claim 2, wherein
the gap amount varying section varies the gap amount of the gap in accordance with a level of the voltage applied, and
when the mode switching section switches the operation mode to the peak detection mode,
the filter drive section varies the voltage to be applied to the gap varying section in a stepwise manner at voltage intervals corresponding to a peak detection pitch smaller than a measurement pitch.

4. The spectroscopic measurement device according to claim 2, wherein
the gap amount varying section varies the gap amount of the gap in accordance with a level of the voltage applied, and
when the mode switching section switches the operation mode to the peak detection mode,
the filter drive section applies an analog voltage continuously varying to the gap amount varying section.

5. The spectroscopic measurement device according to claim 4, further comprising:
a differentiating circuit,
wherein the detection section outputs a detection signal corresponding to the light intensity of the light detected,
the differentiating circuit performs differential processing on the detection signal, and
the peak detection section detects the peak-corresponding gap amount based on the detection signal on which the differential processing is performed by the differentiating circuit.

6. A spectroscopic measurement method adapted to measure a dispersion spectrum of measurement object light by controlling a variable wavelength interference filter having a first reflecting film and a second reflecting film opposed to the first reflecting film across a gap of a predetermined gap amount, the method comprising:
detecting a peak-corresponding gap amount, which is a gap amount for taking out the light with a peak wavelength of the measurement object light using the variable wavelength interference filter; and
measuring the dispersion spectrum by varying the gap amount of the gap to gap amounts with predetermined measurement intervals, and the peak-corresponding gap amount corresponding to the peak wavelength in a stepwise manner, and obtaining the light intensities corresponding to the gap amounts with the predetermined measurement intervals, and the peak-corresponding gap amount.

7. A spectroscopic measurement device comprising:
a variable wavelength interference filter having
a first reflecting film adapted to partially reflect measurement object light incident to the first reflecting film and partially transmit the measurement object light,
a second reflecting film opposed to the first reflecting film across a gap of a predetermined gap amount, and adapted to partially reflect the measurement object light incident to the second reflecting film and partially transmit the measurement object light, and
a gap amount varying section adapted to vary the gap amount; and
a control section adapted to control the variable wavelength interference filter to analyze a dispersion spectrum of measurement object light,
wherein the control section includes
a peak detection section adapted to detect a peak-corresponding gap amount, which is a gap amount when the light intensity of the measurement object light transmitted through the variable wavelength interference filter shows a local maximum point,
a filter drive section adapted to vary the gap amount of the gap to constant interval gap amounts at a predetermined measurement pitch, and the peak-corresponding gap amount in a stepwise manner, and
a spectroscopic analysis section adapted to obtain the light intensities corresponding respectively to the constant interval gap amounts and the peak-corresponding gap amount, and obtain the dispersion spectrum.
